(19) United States
(12) Patent Application Publication
(10) Pub. No.: US 2026/0238466 A1
(43) Pub. Date: Aug. 13, 2026

(54) PHOTON DETECTOR, QUANTUM CRYPTOGRAPHY SYSTEM, AND CIRCUIT

(71) Applicant: NEC Corporation, Tokyo (JP)

(72) Inventor: Seigo TAKAHASHI, Tokyo (JP)

(73) Assignee: NEC Corporation, Tokyo (JP)

(21) Appl. No.: 19/463,241

(22) Filed: Jan. 29, 2026

(30) Foreign Application Priority Data
Feb. 7, 2025 (JP) 2025-019202

(51) Int. Cl. H04L 9/08

(52) U.S. Cl. CPC H04L 9/0858

(57) ABSTRACT

There is provided a photon detector including an avalanche photodiode, a bias voltage application circuit that applies a bias voltage to an input of the avalanche photodiode, a gate voltage application circuit that applies a gate voltage for superimposing an alternating-current component on the bias voltage, a filter disposed on an output side of the avalanche photodiode, and an impedance adjustment circuit disposed between the avalanche photodiode and the filter.

### INCORPORATION BY REFERENCE

This application is based upon and claims the benefit of priority from Japanese patent application No. 2025-019202, filed on Feb. 7, 2025, the disclosure of which is incorporated herein in its entirety by reference.

### TECHNICAL FIELD

The present disclosure relates to a photon detector, a quantum cryptography system, and a circuit.

### BACKGROUND ART

JP 2012-98299 A discloses a photon detection system that may be operated at a high frequency to emphasize presence of a single-photon signal without increasing bias required at both ends of a detector.

### SUMMARY

As a result of miniaturizing and integrating a related photon detector onto a substrate, photon detection performance is deteriorated. Therefore, an example object of the present disclosure is to provide a circuit capable of miniaturizing a detector without deteriorating detection performance.

A photon detector according to an example aspect of the present disclosure is a photon detector including
an avalanche photodiode,
a bias voltage application circuit that applies a bias voltage to an input of the avalanche photodiode,
a gate voltage application circuit that applies a gate voltage for superimposing an alternating-current component on the bias voltage,
a filter disposed on an output side of the avalanche photodiode, and
an impedance adjustment circuit disposed between the avalanche photodiode and the filter.

A quantum cryptography system according to an example aspect of the present disclosure is a quantum cryptography system including
a photon detector including
an avalanche photodiode,
a bias voltage application circuit that applies a bias voltage to an input of the avalanche photodiode,
a gate voltage application circuit that applies a gate voltage by superimposing an alternating-current component on the bias voltage,
a filter disposed on an output side of the avalanche photodiode, and
an impedance adjustment circuit disposed between the avalanche photodiode and the filter, and
a quantaum key distribution device.

A circuit according to an example aspect of the present disclosure is a circuit including
an avalanche photodiode,
a bias voltage application circuit that applies a bias voltage to an input of the avalanche photodiode,
a gate voltage application circuit that applies a gate voltage by superimposing an alternating-current component on the bias voltage,
a filter that removes the alternating-current component of the gate voltage, the filter being disposed on an output side of the avalanche photodiode, and
a delay circuit disposed between the avalanche photodiode and the filter.

An example advantage according to the present disclosure is to provide a circuit capable of miniaturizing a detector without deteriorating detection performance.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a circuit diagram of a related photon detector;

FIG. 2 is a circuit diagram of a photon detector according to the present disclosure;

FIG. 3 is a diagram illustrating transmission characteristics of a filter according to the present disclosure; and

FIG. 4 is a diagram illustrating a change in a detection signal in a case where a delay is changed by the photon detector according to the present disclosure.

### EXAMPLE EMBODIMENTS

### Description of Related Gated Single-Photon Detector

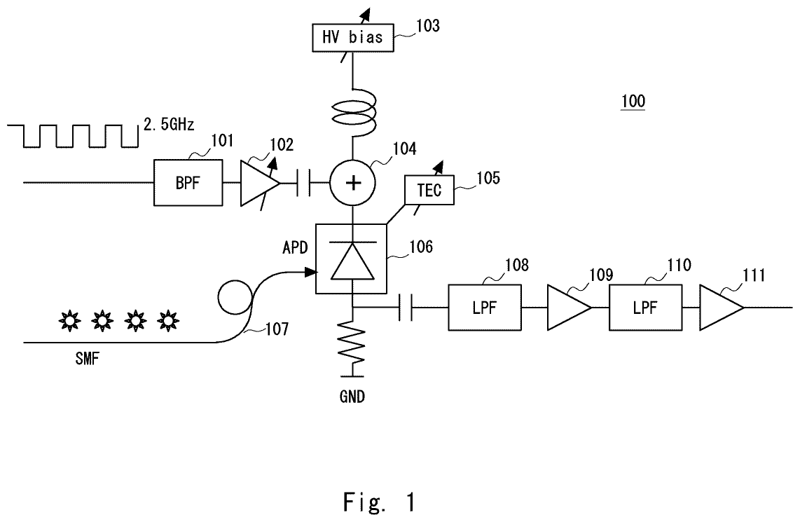

FIG. 1 is a circuit diagram of a related photon detector. The related photon detector will be described with reference to FIG. 1.

As illustrated in FIG. 1, a related photon detector 100 includes a bandpass filter (BPF) 101, a variable amplifier 102, a bias voltage application circuit 103, a coupler 104, a thermoelectric cooler (TEC) 105, an avalanche photodiode (APD) 106, a single-mode fiber (SMF) 107, a low-pass filter (LPF) 108, an amplifier 109, a low-pass filter (LPF) 110, and an amplifier 111.

The BPF 101 is connected to a gate voltage application circuit, and removes harmonics from a gate voltage including harmonic components generated from the gate voltage application circuit. At that time, the gate voltage changes from a rectangular wave to a sinusoidal wave.

The variable amplifier 102 is connected to the BPF 101, and amplifies the gate voltage input from the BPF 101. An amplification factor of the variable amplifier 102 is variable. The variable amplifier 102 is connected to the coupler 104 via a capacitor.

The bias voltage application circuit 103 applies a constant bias voltage to the input of the APD 106. The bias voltage application circuit is connected to the coupler 104 through a coil.

The coupler 104 couples the bias voltage with the gate voltage. The gate voltage, which is an alternating-current component, is superimposed on the bias voltage. The coupler 104 is connected to the cathode of the APD 106.

The SMF 107 transmits a single photon sent from a quantum key distribution device of a quantum cryptography system, and causes the single photon to be incident on the APD 106.

The APD 106 superimposes the detected single-photon signal onto a charge pulse in which the gate voltage leaks through a parasitic capacitance component of the APD 106 to generate an output signal. While the input of the APD 106 is set to the cathode and the output is set to the anode, the output may be set to the anode and the input may be set to the cathode. The anode of the APD is connected to the ground potential through a resistor. The output signal is transmitted to a detector through the capacitor, the LPFs 108 and 110, the amplifiers 109 and 111, and the like.

The Tec 105 cools the APD 106.

The LPF 108 and the LPF 110 are disposed on the output side of the APD 106. The LPF 108 and the LPF 110 remove a band of the alternating-current component of the gate voltage, and remove the charge pulse to extract only a photon signal. The amplifier 109 and the amplifier 111 are disposed on the output side of the APD 106. The amplifier 109 and the amplifier 111 amplify the output signal.

Although descriptions are omitted, the symbols of the electric circuits, such as the coil, capacitor, resistor, and the like illustrated in FIG. 1 have functions that are generally understood.

In order to miniaturize the photon detector, it is desired to minimize wiring of the variable amplifier 102 and APD 106 and the APD 106 and LPFs 108 and 110 and amplifiers 109 and 111. However, if the wiring of the portion is shortened to achieve a miniaturized substrate, there has been a problem that photon detection performance is inferior to that of the circuit with the longer wiring length before being miniaturized.

### Description of Photon Detector According to Example Embodiment

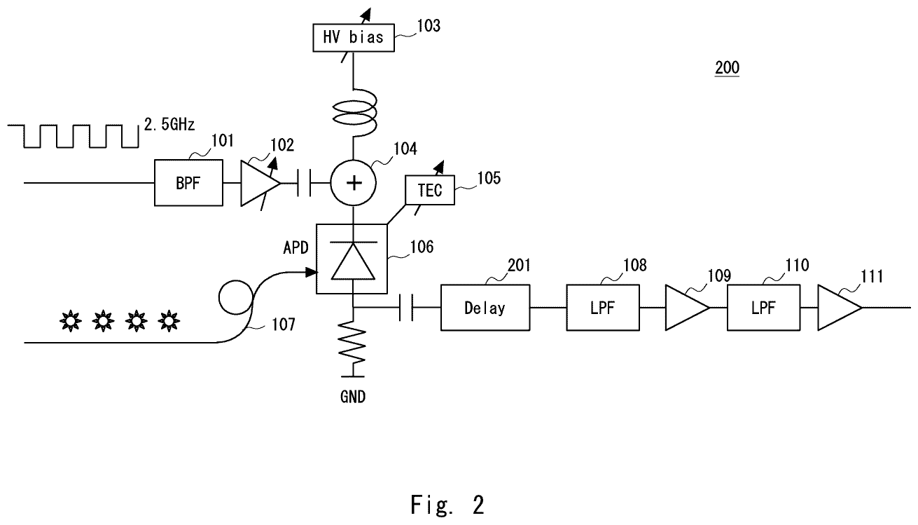

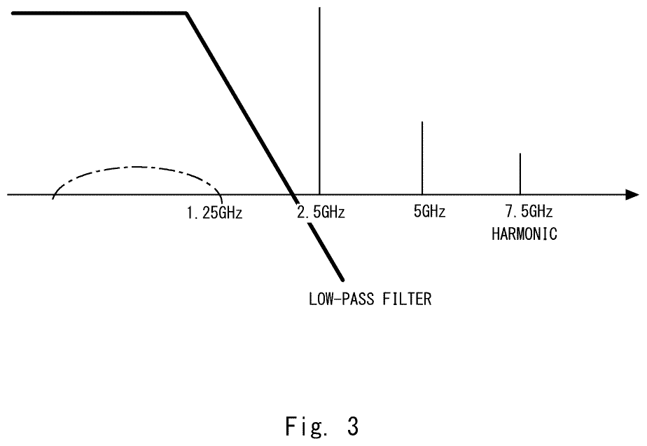

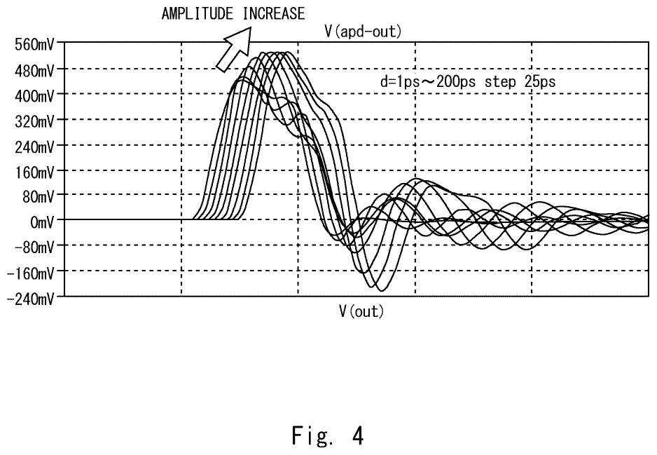

FIG. 2 is a circuit diagram of the photon detector according to the present disclosure. FIG. 3 is a diagram illustrating transmission characteristics of a filter according to the present disclosure. FIG. 4 is a diagram illustrating a change in a detection signal in a case where a delay is changed by the photon detector according to the present disclosure. A photon detector according to an example embodiment will be described with reference to FIGS. 2 to 4. While the photon detector is described as a single-photon detector to be used in the quantum cryptography system in the present disclosure, it may also be used as a detector of a sensor or an analysis device.

As illustrated in FIG. 2, in a photon detector 200 according to the example embodiment, a delay circuit 201 is disposed between an APD 106 and an LPF 108 in addition to the configuration of the related photon detector 100. While the delay circuit 201 is located next to a capacitor in FIG. 2, it may be on the side of the APD 106 before the capacitor.

The delay circuit 201 is a delay line, and delays a cycle of an output signal.

FIG. 4 illustrates data obtained by simulating the output signal in a case where the output signal is delayed by 25 ps under a condition that a gate voltage is set to 2.5 GHz, that is, one cycle length is set to 400 ps. As illustrated in FIG. 4, the output signal rises from 450 mV to 530 mV in a case where the output signal is delayed from 1 ps to 100 ps, that is, from 0 to ¼ cycle, and the output signal stops rising in a case where the output signal is delayed by equal to or more than ¼ cycle.

Thus, the delay circuit 201 preferably delays the output signal by equal to or more than ¼ cycle of the gate voltage.

The output of the APD 106 is a high-impedance output. Since the filter normally has a 50-ohm input, there is an impedance mismatch. If the connection is made over a short distance and there is no delay, the impedance mismatch does not become apparent. If a delay is applied to the photon detection circuit, the mismatch becomes apparent and peaking is applied to a passband, whereby the output increases. In view of the above, the delay circuit 201 may also be referred to as an impedance adjustment circuit.

The gate voltage may be a rectangular wave or a sinusoidal wave. In a case of using a rectangular wave for the gate voltage, a BPF 101 is removed. Even in that case, the low-pass filters LPF 108 and 110 block a band of an alternating-current component of the gate voltage of equal to or more than 2.5 GHz in harmonic components included in the rectangular wave if the cycle of the gate voltage is 2.5 GHz as illustrated in FIG. 3.

As illustrated in FIG. 3, the bandpass filter 101 is a filter that passes a specific frequency such as 2.5 GHz.

With the configuration described above, a circuit capable of miniaturizing a detector without deteriorating detection performance is provided.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments may also be described as the following Supplementary Notes, but are not limited to the following.

### Supplementary Note 1

A photon detector including:
an avalanche photodiode;
a bias voltage application circuit that applies a bias voltage to an input of the avalanche photodiode;
a gate voltage application circuit that applies a gate voltage for superimposing an alternating-current component on the bias voltage;
a filter disposed on an output side of the avalanche photodiode; and
an impedance adjustment circuit disposed between the avalanche photodiode and the filter.

### Supplementary Note 2

The photon detector according to Supplementary Note 1, in which a filter that blocks a band of the alternating-current component of the gate voltage is used as the filter.

### Supplementary Note 3

The photon detector according to Supplementary Note 2, in which a delay line is used as the impedance adjustment circuit.

### Supplementary Note 4

The photon detector according to Supplementary Note 2, in which the filter includes a low-pass filter or a notch filter.

### Supplementary Note 5

The photon detector according to Supplementary Note 3, in which the delay line delays an output signal by equal to or more than ¼ of a cycle length of the gate voltage.

### Supplementary Note 6

The photon detector according to Supplementary Note 1, in which a bandpass filter is disposed in the gate voltage application circuit and the gate voltage is caused to pass through the bandpass filter to make the gate voltage a sinusoidal wave.

### Supplementary Note 7

The photon detector according to Supplementary Note 1, in which
the gate voltage includes a rectangular wave, and
a harmonic component included in the rectangular wave is blocked using a low-pass filter as the filter.

### Supplementary Note 8

A quantum cryptography system including:
a photon detector including:
an avalanche photodiode;
a bias voltage application circuit that applies a bias voltage to an input of the avalanche photodiode;
a gate voltage application circuit that applies a gate voltage by superimposing an alternating-current component on the bias voltage;
a filter disposed on an output side of the avalanche photodiode; and
an impedance adjustment circuit disposed between the avalanche photodiode and the filter; and
a quantum key distribution device.

### Supplementary Note 9

The quantum cryptography system according to Supplementary Note 8, in which a filter that blocks a band of the alternating-current component of the gate voltage is used as the filter.

### Supplementary Note 10

A circuit including:
an avalanche photodiode;
a bias voltage application circuit that applies a bias voltage to an input of the avalanche photodiode;
a gate voltage application circuit that applies a gate voltage by superimposing an alternating-current component on the bias voltage;
a filter that removes the alternating-current component of the gate voltage, the filter being disposed on an output side of the avalanche photodiode; and
a delay circuit disposed between the avalanche photodiode and the filter.

Some or all of the elements (e.g. configurations and functions) described in Supplementary Notes 2 to 7 dependent on Supplementary Note 1 {e.g. photon detector} may also be dependent on Supplementary Notes 8 {e.g. quantum cryptography system} and 10 {e.g. circuit} with a dependency relationship similar to that of Supplementary Notes 2 to 7. Some or all of the elements described in any Supplementary Note may be applied to various types of hardware, software, recording means for recording software, systems, and methods.

What is claimed is:

1. A photon detector comprising:
an avalanche photodiode;
a bias voltage application circuit that applies a bias voltage to an input of the avalanche photodiode;
a gate voltage application circuit that applies a gate voltage for superimposing an alternating-current component on the bias voltage;
a filter disposed on an output side of the avalanche photodiode; and
an impedance adjustment circuit disposed between the avalanche photodiode and the filter.

2. The photon detector according to claim 1, wherein a filter that blocks a band of the alternating-current component of the gate voltage is used as the filter.

3. The photon detector according to claim 2, wherein a delay line is used as the impedance adjustment circuit.

4. The photon detector according to claim 2, wherein the filter includes a low-pass filter.

5. The photon detector according to claim 3, wherein the delay line delays an output signal by equal to or more than ¼ of a cycle length of the gate voltage.

6. The photon detector according to claim 1, wherein a bandpass filter is disposed in the gate voltage application circuit and the gate voltage is caused to pass through the bandpass filter to make the gate voltage a sinusoidal wave.

7. The photon detector according to claim 1, wherein
the gate voltage includes a rectangular wave, and
a harmonic component included in the rectangular wave is blocked using a low-pass filter as the filter.

8. A quantum cryptography system comprising:
a photon detector including:
an avalanche photodiode;
a bias voltage application circuit that applies a bias voltage to an input of the avalanche photodiode;
a gate voltage application circuit that applies a gate voltage by superimposing an alternating-current component on the bias voltage;
a filter disposed on an output side of the avalanche photodiode; and
an impedance adjustment circuit disposed between the avalanche photodiode and the filter; and
a quantum key distribution device.

9. The quantum cryptography system according to claim 8, wherein a filter that blocks a band of the alternating-current component of the gate voltage is used as the filter.

10. The quantum cryptography system according to claim 9, wherein a delay line is used as the impedance adjustment circuit.

11. The quantum cryptography system according to claim 9, wherein the filter includes a low-pass filter.

12. The quantum cryptography system according to claim 10, wherein the delay line delays an output signal by equal to or more than ¼ of a cycle length of the gate voltage.

13. The quantum cryptography system according to claim 8, wherein a bandpass filter is disposed in the gate voltage application circuit and the gate voltage is caused to pass through the bandpass filter to make the gate voltage a sinusoidal wave.

14. The quantum cryptography system according to claim 8, wherein
the gate voltage includes a rectangular wave, and
a harmonic component included in the rectangular wave is blocked using a low-pass filter as the filter.

15. A circuit comprising:
an avalanche photodiode;
a bias voltage application circuit that applies a bias voltage to an input of the avalanche photodiode;
a gate voltage application circuit that applies a gate voltage by superimposing an alternating-current component on the bias voltage;
a filter that removes the alternating-current component of the gate voltage, the filter being disposed on an output side of the avalanche photodiode; and
a delay circuit disposed between the avalanche photodiode and the filter.

16. The circuit according to claim 15, wherein a filter that blocks a band of the alternating-current component of the gate voltage is used as the filter.

17. The circuit according to claim 16, wherein a delay line is used as the delay circuit.

18. The circuit according to claim 16, wherein the filter includes a low-pass filter.

19. The circuit according to claim 17, wherein the delay line delays an output signal by equal to or more than ¼ of a cycle length of the gate voltage.

20. The circuit according to claim 15, wherein a bandpass filter is disposed in the gate voltage application circuit and the gate voltage is caused to pass through the bandpass filter to make the gate voltage a sinusoidal wave.
